(19) United States
(12) Patent Application Publication
(10) Pub. No.: US 2026/0245529 A1
(43) Pub. Date: Aug. 20, 2026

(54) ELECTRONIC DEVICE AND METHOD FOR MANAGING THE RESOURCE

(71) Applicant: MEDIATEK INC., Hsinchu City (TW)

(72) Inventors: Li LIN, Hsinchu City (TW); Wei-Shuo CHEN, Hsinchu City (TW); Cheng-Che CHEN, Hsinchu City (TW)

(21) Appl. No.: 19/535,161

(22) Filed: Feb. 10, 2026

Related U.S. Application Data
(60) Provisional application No. 63/759,382, filed on Feb. 17, 2025.

(51) Int. Cl. G09G 5/14; G09G 3/20

(52) U.S. Cl. CPC G09G 5/14; G09G 3/20; G09G 2320/0613; G09G 2330/022; G09G 2330/023; G09G 2340/0435; G09G 2354/00; G09G 2360/08

(57) ABSTRACT

An electronic device includes a memory, a display, and a processor coupled to the memory and the display. The memory is configured to store a program. The processor is configured to execute the program to implement the first application, the second application, and a frame rate controller. The processor is configured to control the display to display a first window associated with the first application and a second window associated with the second application. The frame rate controller is configured to receive the first application hint from the first application. The frame rate controller is further configured to obtain the system information of the electronic device. The frame rate controller is further configured to determine the first target frame rate for the first application and the second target frame rate for the second application, based at least in part on the first application hint and the system information.

### CROSS REFERENCE TO RELATED APPLICATIONS

This application claims priority of U.S. Provisional Application Serial Number 63/759,382, filed on February, 17, 2025, the entirety of which is incorporated by reference herein.

### TECHNICAL FIELD

The present disclosure relates to resource management, and, in particular, it relates to resource management in a multi-window scenario.

### BACKGROUND

As monitor size and computation power of mobile devices continue to increase, multi-window displays have become more and more common. When there are multiple windows displayed on a screen, it may be necessary to allocate resources to each window. Furthermore, this is important toward achieving a balance between user experience and power consumption. However, applying the same resource control strategy for all windows is not ideal. For example, if all windows use the highest possible frame rate, power consumption will be high, leading to rapid battery depletion. If all windows apply a limited frame rate, then no window can be displayed at the full frame rate, and user experience will suffer. Resource allocation and frame rate control methods should take the scenario of the application into consideration.

Thus, a resource allocation or frame rate control method is required to solve the above-mentioned problem.

### BRIEF SUMMARY

An embodiment of the present disclosure provides an electronic device comprising a memory, a display, and a processor coupled to the memory and the display. The memory is configured to store a program. The processor is configured to execute the program and implement the first application, the second application, and a frame rate controller. The processor is configured to control the display to display the first window associated with the first application and the second window associated with the second application. The frame rate controller is configured to receive the first application hint from the first application. The frame rate controller is further configured to obtain the system information of the electronic device. The frame rate controller is further configured to determine the first target frame rate for the first application and the second target frame rate for the second application, based at least in part on the first application hint and the system information. The frame rate controller is further configured to perform a system resource allocation operation based on the first target frame rate and the second target frame rate.

An embodiment of the present disclosure provides a method for managing the resource, comprising the following operations. The processor of the electronic device executes a program stored in a memory to implement the first application, the second application, and the frame rate controller. The processor controls the display to display the first window associated with the first application and the second window associated with the second application. The frame rate controller receives a first application hint from the first application. The frame rate controller obtains system information of the electronic device. The frame rate controller determines the first target frame rate for the first application and the second target frame rate for the second application, based at least in part on the first application hint and the system information. The frame rate controller performs a system resource allocation operation based on the first target frame rate and the second target frame rate.

### BRIEF DESCRIPTION OF THE DRAWINGS

The present disclosure can be more fully understood by reading the subsequent detailed description and examples with references made to the accompanying drawings, wherein:

FIG. 1 is the block diagram of the electronic device in accordance with embodiments of the present disclosure;

FIG. 2A is a flow diagram of the method for managing the resource in accordance with embodiments of the present disclosure;

FIG. 2B is a flow diagram of the method for managing the resource in accordance with embodiments of the present disclosure.

FIG. 3 is a flow diagram of the method for managing the resource in accordance with embodiments of the present disclosure; and

FIG. 4 is a flow diagram of the method for managing the resource in accordance with embodiments of the present disclosure.

### DETAILED DESCRIPTION

The following description is made for the purpose of illustrating the general principles of the disclosure and should not be taken in a limiting sense. The scope of the disclosure is best determined by reference to the appended claims.

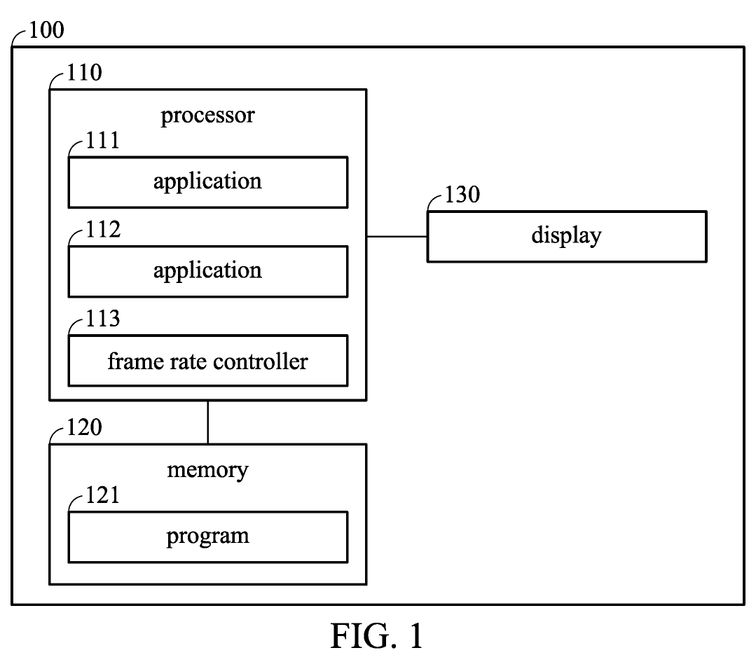

FIG. 1 is the block diagram of the electronic device 100 in accordance with embodiments of the present disclosure. The electronic device 100 comprises a processor 110, a memory 120, and a display 130. The processor 110, the memory 120, and the display 130 may connect with each other through a buffer and exchange information with each other. For example, the electronic device 100 may be a mobile device, a smartphone, a tablet computer, a notebook computer, a desktop computer, a wearable device, or a smartwatch. The electronic device 100 may be implemented in the form of one or more integrated-circuit (IC) chips.

The processor 110 provides the required process and calculate ability to implement the method of the embodiments. For example, the processor 110 may be able to perform operating systems, programs, software, modules, applications, and functions. In some embodiments, the processor 110 may be implemented in the form of hardware with electronic components, such as transistors, diodes, capacitors, resistors, or inductors. These components are configured and arranged to achieve specific purposes in accordance with the embodiments of the present disclosure. For example, the processor 110 may include a general-purpose processor, a central processing unit (CPU), a graphics processing unit (GPU),Neural Processing Unit (NPU), an image signal processor, a digital signal processor, a microcontroller unit (MCU), and/or related chip set.

The memory 120 stores data required by the processor 110. The memory 120 may include non-volatile memories, such as read only memory (ROM), flash memory, hard disk drive, and solid-state disk. The memory 120 may also include volatile memories, such as dynamic random-access memory (DRAM) and static random-access memory (SRAM). In some embodiments, the memory 120 stores a program 121, such as a computer-readable instruction. When the program 121 is read and executed by the processor 110, the program 121 causes the processor 110 to implement methods according to the embodiments of the present disclosure.

In some embodiments, the processor 110 is configured to read the program 121 and implement the application 111 (the first application 111), the application 112 (the second application 112), and the frame rate controller 113. In other words, the application 111, the application 112, and the frame rate controller 113 are applications or software modules implemented by the processor 110. The applications 111 and 112 may be able to generate images at various different frame rates, such as 30, 60, 75, 90, or 120 frame per second (FPS). In some embodiments, the applications 111 and 112 may be, but not limited to, game applications, live stream applications, video applications, or browser. The function of the frame rate controller 113 is described in more detail below.

The display 130 is configured to display images, such as images generated by the applications 111 and 112. The display 130 may comprise a single display panel or a plurality of display panels. For example, the display 130 may be a Liquid Crystal Display (LCD), an Organic Light-Emitting Diode (OLED) display, a flexible display (e.g., in a foldable smartphone), or a multi-screen setup (e.g., a dual-screen device having two physically separate screens or an external monitor connected to the electronic device 100). In some embodiments, the electronic device 100 supports multi-window display environment. The display 130 is configured to display a first window associated with the application 111 and a second window associated with the application 112. It should be note that the arrangement of the windows is not limited. For instance, the first window and the second window may be displayed simultaneously on a same display panel (e.g., in a split-screen mode or a picture-in-picture mode). Alternatively, in a multi-screen or foldable scenario, the first window may be displayed on a first display panel (or a first region of a flexible display) while the second window is displayed on a second display panel (or a second region of the flexible display). The processor 110 may implement any number of applications, and the images generated by these applications may be respectively displayed in a window on the display 130.

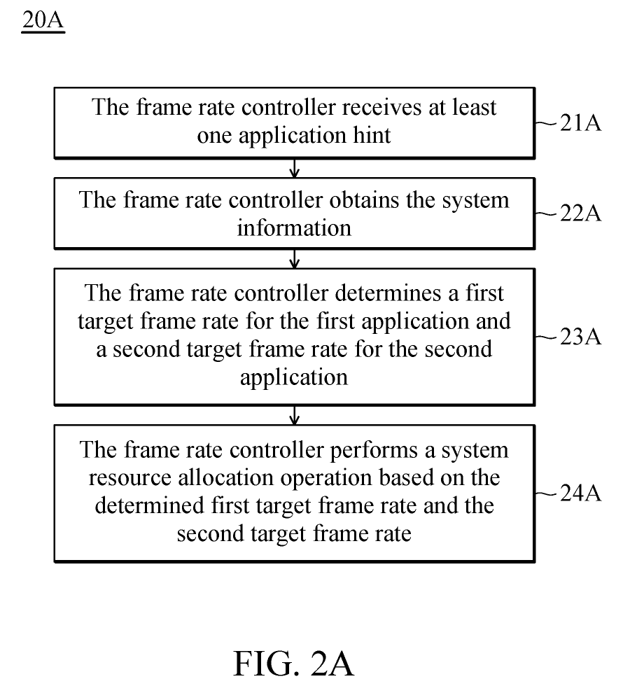

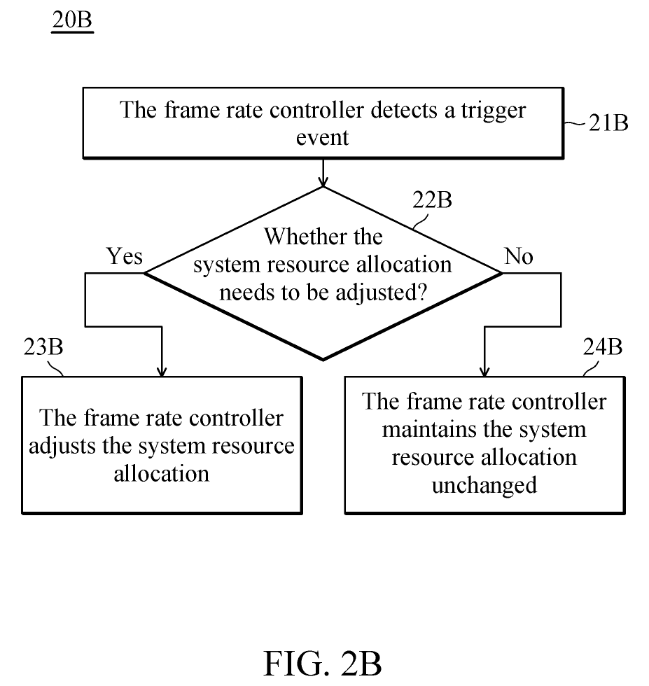

FIG. 2A is a flow diagram of the method 20A for managing the resource in accordance with embodiments of the present disclosure. In operation 21A, the frame rate controller 113 receives at least one application hint. For example, the frame rate controller 113 receives a first application hint from the application 111. Optionally, in some embodiments, the frame rate controller 113 may also receive a second application hint from the application 112 (as depicted in FIG. 1). It should be understood that while the frame rate controller 113 is capable of aggregating hints from multiple applications, the present disclosure does not strictly require every running application to provide a hint. The frame rate controller 113 may operate effectively even if only a subset of applications (e.g., only the application 111) provides the application hint. As described in the claims, the application hint may comprise a variety of information, such as a scenario type of the application (e.g., game, video), a current frame rate, a requested frame rate, a current image quality, a requested image quality, or an identification (ID) of a critical thread being executed by the application.

In some embodiments, the scenario type of the application indicates the scenario that the application is in. In some embodiments, the scenario type of the application may be categorize the application as a game, a video playback, videotelephony session, or a live stream session. In other words, the window of the application is displaying contents corresponding to the game, the video, the videotelephony, or the live stream. Furthermore, the scenario type may indicate a specific phase of the application, such as a game match, game in progress, game menu, or game lobby. For example, the "game match" or "game in progress" scenario refers to a state of active gameplay. In this state, the application may communicate with a remote game server to synchronize game data, and/or perform intensive graphics rendering and logic computation. Therefore, the "game match" scenario typically corresponds to a high performance requirement. In contrast, the "game menu" scenario and the "game lobby" scenario mean that the window of the application is primarily displaying user interface (UI) elements or static images, which typically corresponds to a lower performance requirement compared to the active gameplay.

The frame rate of the application may be, for example, 30 FPS, 60 FPS, 90 FPS, 120 FPS. The image quality of the application may indicate the resolution of the image. For example, the image quality of the application may be 360P, 480P, 720P, 1080P. Furthermore, the image quality may indicate a level of graphical fidelity or rendering detail. For instance, the image quality may correspond to specific rendering parameters, such as an anti-aliasing level (e.g., MSAA, TXAA), a shadow detail level, a texture quality, a motion blur effect, or a particle effect. Alternatively, the image quality may be defined by a comprehensive configuration profile (or a tiered setting) integrating multiple rendering parameters. These profiles may include, for example, an energy-saving mode (or battery-saver mode), a smooth mode (or performance mode), a high-quality mode (or exquisite mode), and an ultra mode (or extreme mode).

The thread that the application is executing may be the logical thread, the drawing thread, or the thread configured to communicate with the CPU. The logical thread is configured to control the application. The drawing thread is configured to dram the image which will be displayed on the display 130.

In operation 22A, the frame rate controller 113 obtains the system information (of the electronic device 100). In some embodiments, the system information comprises the system status information and the system performance index. In some embodiments, the system status information comprises the remaining battery power, the temperature, or the core architecture. For example, the core architecture may be the number of the cores of the CPU of the electronic device 100 and the computation power of each of the cores of the CPU of the electronic device 100. In some embodiments, the system performance index comprises loading of each core of the CPU of the electronic device 100 or computation power consumed by the threads of operating system.

Loading of the core may refer to the proportion, which is the computation power consumed by the threads executed on the core over the computation power of the core. In other words, the loading of the core may refer to the proportion, which is the total load caused by all the threads currently being executed on the core over the maximum affordable load of the core. In some embodiments, the threads of operating system may be the threads other than the threads of the application. For example, the threads of operating system may comprise the background threads.

In operation 23A, the frame rate controller 113 determines a first target frame rate for the application 111 and a second target frame rate for the application 112. The determination is based on the system information and any available application hints. Specifically, if the frame rate controller 113 receives the first application hint from the application 111, the frame rate controller 113 determines the first target frame rate based on the first application hint and the system information. Regarding the second application 112, the determination logic may vary depending on whether a hint is provided. In some embodiments, the frame rate controller 113 receives a second application hint from the second application 112. In such cases, determining the second target frame rate comprises determining the rate based at least in part on the second application hint, along with the system information and potentially the first application hint. For example, if the second application hint requests a specific frame rate (e.g., for video playback), the controller considers this request against the system's current status. However, it is possible that not all applications provide application hints (e.g., legacy applications). In a scenario where the application 112 does not provide a specific hint (or the second application hint is unavailable), the frame rate controller 113 may determine the second target frame rate based on the system information alone, or based on the system information in combination with performance statistical data monitored by the system (e.g., historical thread loading or touch event frequency of the application 112). Furthermore, regardless of whether the second hint is received, the frame rate controller 113 may determine the second target frame rate based on the first application hint provided by the application 111. For instance, if the first application hint indicates that the application 111 is in a high-priority game match scenario, the frame rate controller 113 may lower the second target frame rate of the application 112 to conserve system resources, even if the application 112 did not explicitly request a lower frame rate. For example, the target frame rate may be 30 FPS, 60 FPS, 90 FPS, or 120 FPS.

In some embodiments, the frame rate controller 113 determines the target frame rate(s) via consulting a mapping table (or a policy database) stored in the memory 120. The table records multiple combinations of input parameters and their corresponding target frame rate configurations. Specifically, the input parameters may include the first application hint (e.g., scenario type of the first application), the second application hint (e.g., scenario type of the second application, if available), and the system information (e.g., battery level or thermal status). The table maps these combinations to a specific resource allocation policy, which defines the first target frame rate for the application 111 and the second target frame rate for the application 112. For example, one entry in the table may indicate that when the first application hint is "Game Match" and the battery level is "Low", the first target frame rate is set to 60 FPS (to ensure gameplay) while the second target frame rate is strictly limited to 15 FPS (to save power).

In some embodiments, the frame rate controller 113 determines the target frame rate further based on the computation power currently consumed by the application (e.g., CPU loading or GPU usage associated with the application's threads). In some embodiments, the frame rate controller 113 determines the target frame rate further based on a user interaction event detected on the window displaying the application. The display 130 may be a touch screen, and the user interaction event may comprise a click, a touch input, a swipe gesture, a scroll gesture, or a pinch gesture. If a user interaction event is detected on a specific window (e.g., the first window), it indicates that the user's focus is currently on that window. Consequently, the frame rate controller 113 may increase the target frame rate of the corresponding application to ensure a smooth response. Conversely, if no user interaction event is detected on a window for a certain period, the frame rate controller 113 may determine that the window is idle or in the background, and thus decrease its target frame rate to save power.

In operation 24A, the frame rate controller 113 performs a system resource allocation operation based on the determined first target frame rate and the second target frame rate. Specifically, the frame rate controller 113 adjusts the operating parameters of the processor 110 (or the system) to align the actual performance with the target frame rates. For example, if the first target frame rate is lower than a current frame rate of the first application 111, the frame rate controller 113 may decrease an operating frequency of the processor (e.g., via Dynamic Voltage and Frequency Scaling, DVFS), reduce the number of active cores allocated to the first application 111 (e.g., via CPU affinity settings), or reduce the CPU time slices assigned by the scheduler. Conversely, if the first target frame rate is substantially equal to the current frame rate, the frame rate controller 113 may maintain the current resource allocation. Similarly, the resource allocation for the second application 112 is adjusted or maintained based on the second target frame rate. By precisely controlling the resources for each window, the electronic device 100 minimizes energy consumption while satisfying the distinct performance requirements of the multi-window environment.

The method 20A may be executed periodically to dynamically adapt to the changing environment. Furthermore, the method 20A may be triggered in response to a change in any of the influencing factors. For example, when the application hint is updated (e.g., the first application 111 switches from a game menu scenario to a game match scenario), when the system information changes significantly (e.g., the battery level drops below a threshold or the device temperature rises), or when a user interaction event (e.g., a click, touch, or gesture) is detected on one of the windows, the frame rate controller 113 may re-execute the method 20A to update the target frame rates and re-allocate the system resources accordingly. Refer to FIG. 2B, which is a flow diagram of the method 20B for managing the resource in accordance with embodiments of the present disclosure. Method 20B may be performed after the operation 24A. In operation 21B, the frame rate controller 113 detects a trigger event. The trigger event may comprise detecting a change in the application hint (e.g. receiving an updated or new application hint) and/or the system information. Specifically, the trigger event may comprise that the application hint is updated, receiving a new application hint, that the system information changes significantly, that a user interaction event is detected on one of the windows, that the display setting of at least one of the first application 111 and the second application 112 is changed, or detecting a frame drop in at least one of the windows displayed on the display 130.

In operation 22B, the frame rate controller 113 determines whether the system resource allocation needs to be adjusted. In some embodiments, the frame rate controller 113 may determine whether the current system resource (may have changed after last time that the operation 24A is performed) can support the first target frame rate and the second target frame rate determined in operation 23A (may be referred to as the current first target frame rate and the current second target frame rate). If the current system resource can support the current first target frame rate and the current second target frame rate, the frame rate controller 113 may determine that the current system resource doesn’t need to be adjusted. Otherwise, the frame rate controller 113 may determine that the current system resource needs to be adjusted.

In some embodiments, the frame rate controller 113 may determine an updated first target frame rate and an updated second target frame rate based at least in part on the updated first application hint and the system information as described in operation 23A. Then, the frame rate controller 113 may compare the updated first target frame rate with the current first target frame rate and compare the updated second target frame rate with the current target frame rate. If the updated first target frame rate is equal to the current first target frame rate and the updated second target frame rate is equal to the current second target frame rate, the frame rate controller 113 may determine that the current resource allocation doesn’t need to be adjusted. Otherwise, the frame rate controller 113 may determine that the current resource allocation needs to be adjusted. It is noted that the when the updated target frame rate is lower than the current target frame rate, the frame rate controller 113 may also adjust the resource allocation to save the resource.

When the frame rate controller 113 determines that the system resource allocation needs to be adjusted, operation 23B is performed. In operation 23B, the frame rate controller 113 adjusts the system resource allocation. The frame rate controller 113 may perform operation 23Aand/or operation 24A again to determine the updated resource allocation. When the frame rate controller 113 determines that the system resource allocation doesn’t need to be adjusted, operation 24B is performed. In operation 24B, the frame rate controller 113 maintains the system resource allocation unchanged.

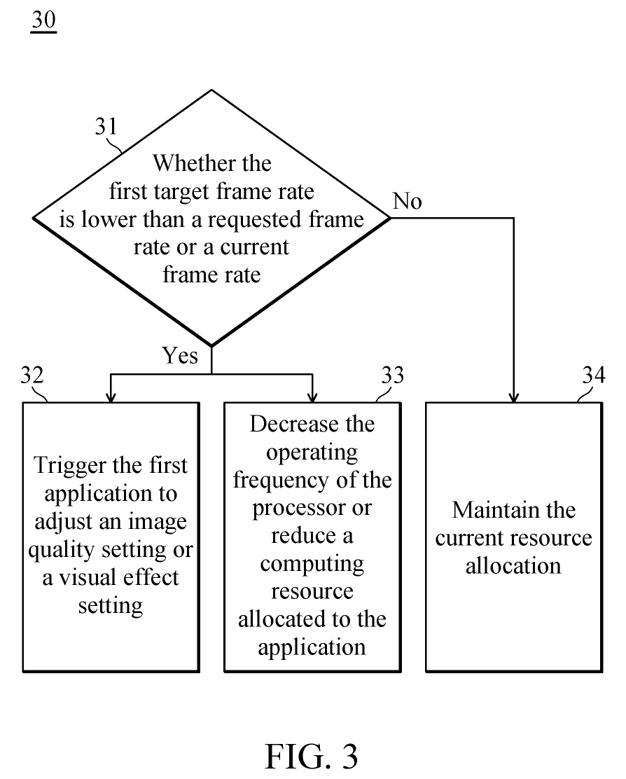

FIG. 3 is a flow diagram of the method 30 for managing system resource in accordance with embodiments of the present disclosure. The method 30 may correspond to the detailed procedures for adjusting the resource allocation in operation 24A. The following takes application 111 as example to describe the method 30. In operation 31, the frame rate controller 113 compares the determined first target frame rate with the status of the first application 111. Specifically, the frame rate controller 113 may determine whether the first target frame rate is lower than a requested frame rate (for the purpose of negotiation) or a current frame rate (for the purpose of enforcement) of the first application 111. When the first target frame rate is lower than the requested frame rate or the current frame rate of the application 111, the frame rate controller 113 executes operation 32 or 33. Conversely, when the first target frame rate is substantially equal to the current frame rate of the application 111, the frame rate controller 113 executes operation 34. It is noted that, in the embodiments of the present disclosure, the determined target frame rate is generally equal to or lower than the requested frame rate of the application to prioritize energy efficiency.

In operation 32, the frame rate controller 113 transmits a notification to the application 111 triggers the first application to adjust an image quality setting or a visual effect setting. Specifically, when the first target frame rate is lower than the requested frame rate, the frame rate controller 113 transmits the notification to the application 111. Upon receiving the notification, the application 111 may autonomously adjust its internal settings, such as decreasing the image quality setting (e.g., lowering resolution or texture details) or disabling certain visual effect settings (e.g., turning off shadows or anti-aliasing). This mechanism allows the first application 111 to adapt to the limited system resources proactively. Consequently, by reducing the rendering workload, the first application 111 can operate smoothly within the limits of the lower first target frame rate, thereby preventing stuttering or excessive power consumption.

Alternatively (or additionally), in operation 33, the frame rate controller 113 performs a system-level enforcement by decreasing the operating frequency of the processor 110 or reduce a computing resource allocated to the application111 when the first target frame rate is lower than a current frame rate of the application 111. For example, the frame rate controller 113 may decrease the available computing power by lowering the clock frequency of the CPU/GPU cores executing the threads of the application 111 (e.g., via DVFS control). The frame rate controller 113 may also migrate the threads of the application 111 to more power-efficient cores (e.g., little cores in a big.LITTLE architecture). By restricting the resources, the frame rate controller 113 physically constrains the performance of the application 111, causing its actual frame rate to decrease towards the first target frame rate. Since the frame rate controller 113 possesses global system information (unlike the individual application), this system-side intervention allows for more precise and stable frame rate control compared to relying solely on the application's self-adaptation.

In operation 34, the frame rate controller 113 maintains the current resource allocation. Specifically, when the first target frame rate is substantially equal to the frame rate of the application 111, the frame rate controller 113 determines that the current system state is optimal or balanced. Consequently, the frame rate controller 113 keeps the resource allocation associated with the first application 111 unchanged. This hysteresis-like behavior prevents frequent and unnecessary adjustments to the system settings, thereby avoiding performance oscillation and reducing control overhead.

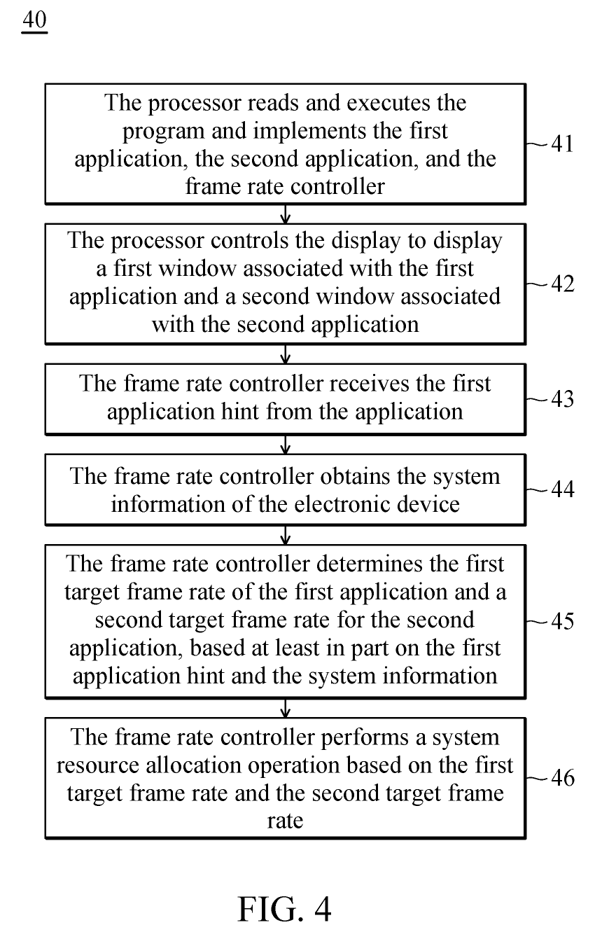

FIG. 4 is a flow diagram of the method 40 for managing the resource in accordance with embodiments of the present disclosure. In operation 41, the processor 110 reads and executes the program 121 and implements the application 111, the application 112, and the frame rate controller 113. In operation 42, the processor 110 is configured to control the display 130 to display a first window associated with the application 111 and a second window associated with the application 112. In operation 43, the frame rate controller 113 receives the first application hint from the application 111. In operation 44, the frame rate controller 113 obtains the system information of the electronic device. In operation 45, the frame rate controller 113 determines the first target frame rate of the application 111 and a second target frame rate for the application 112, based at least in part on the first application hint and the system information. In operation 46, the frame rate controller 113 perform a system resource allocation operation based on the first target frame rate and the second target frame rate.

Embodiments of the present disclosure can receive application hints from the application and obtain system information. Utilizing the application hints and the system information, embodiments of the present disclosure can more precisely determine target frame rate for each of the application. Then, embodiments of the present disclosure can adjust the resource allocation to each application based on the target frame rate. Thus, embodiments of the present disclosure can achieve a balance between user experience and power consumption.

While the disclosure has been described by way of example and in terms of the preferred embodiments, it should be understood that the disclosure is not limited to the disclosed embodiments. On the contrary, it is intended to cover various modifications and similar arrangements. Therefore, the scope of the appended claims should be accorded the broadest interpretation so as to encompass all such modifications and similar arrangements.

What is claimed is:

1. An electronic device, comprising:
a memory, configured to store a program;
a display; and
a processor coupled to the memory and the display, wherein the processor is configured to execute the program to implement a first application, a second application, and a frame rate controller;
wherein the processor is configured to control the display to display a first window associated with the first application and a second window associated with the second application; and
wherein the frame rate controller is configured to:
receive a first application hint from the first application;
obtain system information of the electronic device;
determine a first target frame rate for the first application and a second target frame rate for the second application, based at least in part on the first application hint and the system information;
perform a system resource allocation operation based on the first target frame rate and the second target frame rate.

2. The electronic device as claimed in claim 1, wherein the frame rate controller is configured to transmit a notification to the first application when the first target frame rate is lower than a requested frame rate of the first application, wherein the notification triggers the first application to adjust an image quality setting or a visual effect setting.

3. The electronic device as claimed in claim 1, wherein in the system resource allocation operation, the frame rate controller is configured to decrease an operating frequency of the processor or reduce a computing resource allocated to the first application when the first target frame rate is lower than a current frame rate of the first application.

4. The electronic device as claimed in claim 1, wherein in the system resource allocation operation, the frame rate controller is configured to maintain a current resource allocation associated with the first application when the first target frame rate is substantially equal to a current frame rate of the first application.

5. The electronic device as claimed in claim 1, wherein the first application hint comprises at least one of: a scenario type of the first application, a current frame rate of the first application, a requested frame rate of the first application, a requested image quality of the first application, or an identification (ID) of a thread being executed by the first application.

6. The electronic device as claimed in claim 5, wherein the scenario type indicates that the first application is in a state comprising: a game match, a game menu, a game lobby, a video playback, a videotelephony session, or a live stream session.

7. The electronic device as claimed in claim 1, wherein the system information comprises at least one of: a remaining battery level of the electronic device, a temperature of the electronic device, a core architecture of the processor, a loading of each core of the processor, or a computation power consumed by threads of an operating system of the electronic device.

8. The electronic device as claimed in claim 1, wherein the frame rate controller is further configured to determine the first target frame rate based on the computation power consumed by the first application.

9. The electronic device as claimed in claim 1, wherein the frame rate controller is further configured to determine the first target frame rate based on a user interaction event detected on the first window.

10. The electronic device as claimed in claim 1, wherein the frame rate controller is further configured to:
receive a second application hint from the second application;
wherein determining the second target frame rate comprises determining the second target frame rate based at least in part on the second application hint, and the system information.

11. A method for managing the resource, comprising:
executing, via a processor of an electronic device, a program stored in a memory to implement a first application, a second application, and a frame rate controller;
controlling, via the processor, a display to display a first window associated with the first application and a second window associated with the second application;
receiving, via the frame rate controller, a first application hint from the first application;
obtaining, via the frame rate controller, system information of the electronic device;
determining, via the frame rate controller, a first target frame rate for the first application and a second target frame rate for the second application, based at least in part on the first application hint and the system information;
performing, via the frame rate controller, a system resource allocation operation based on the first target frame rate and the second target frame rate.

12. The method as claimed in claim 11, further comprising:
transmitting, via the frame rate controller, a notification to the first application when the first target frame rate is lower than a requested frame rate of the first application, wherein the notification triggers the first application to adjust an image quality setting or a visual effect setting.

13. The method as claimed in claim 11, wherein the system resource allocation operation comprises:
decreasing, via the frame rate controller, an operating frequency of the processor or reduce a computing resource allocated to the first application when the first target frame rate is lower than a current frame rate of the first application.

14. The method as claimed in claim 11, wherein the system resource allocation operation comprises:
maintaining, via the frame rate controller, a current resource allocation associated with the first application when the first target frame rate is substantially equal to a current frame rate of the first application.

15. The method as claimed in claim 11, wherein the first application hint comprises at least one of: a scenario type of the first application, a current frame rate of the first application, a requested frame rate of the first application, a requested image quality of the first application, or an identification (ID) of a thread being executed by the first application.

16. The method as claimed in claim 15, wherein the scenario type indicates that the first application is in a state comprising: a game match, a game menu, a game lobby, a video playback, a videotelephony session, or a live stream session.

17. The method as claimed in claim 11, wherein the system information comprises at least one of: a remaining battery level of the electronic device, a temperature of the electronic device, a core architecture of the processor, a loading of each core of the processor, or a computation power consumed by threads of an operating system of the electronic device.

18. The method as claimed in claim 11, further comprising:
determining, via the frame rate controller, the first target frame rate based on the computation power consumed by the first application.

19. The method as claimed in claim 11, further comprising:
determining, via the frame rate controller, the first target frame rate based on a user interaction event detected on the first window.

20. The method as claimed in claim 11, further comprising:
receiving, via the frame rate controller, a second application hint from the second application;
wherein determining the second target frame rate comprises determining the second target frame rate based at least in part on the second application hint, and the system information.
